(19) United States
(12) Patent Application Publication
(10) Pub. No.: US 2008/0052527 A1
(43) Pub. Date: Feb. 28, 2008

(54) METHOD AND SYSTEM FOR AUTHENTICATING AND VALIDATING IDENTITIES BASED ON MULTI-MODAL BIOMETRIC TEMPLATES AND SPECIAL CODES IN A SUBSTANTIALLY ANONYMOUS PROCESS

(75) Inventor: John E. Siedlarz, Easton, MD (US)

Correspondence Address: RATNERPRESTIA, P O BOX 980, VALLEY FORGE, PA, 19482-0980, US

(73) Assignee: NATIONAL BIOMETRIC SECURITY PROJECT, Washington, DC (US)

(21) Appl. No.: 11/780,549

(22) Filed: Jul. 20, 2007

Related U.S. Application Data
(60) Provisional application No. 60/840,599, filed on Aug. 28, 2006.

(51) Int. Cl. H04L 9/00; H04L 9/32

(52) U.S. Cl. 713/186

(57) ABSTRACT

An embodiment of the present invention provides a method for authenticating an identity of an individual received from an approved entity against a centralized multi-modal biometric database in an anonymous process. The method includes receiving an authentication request from the approved entity. The authentication request includes a personal reference code and a biometric template for a biometric feature of the individual but no private or personal data. The method further includes determining if any record in the database exists that includes a personal reference code which matches the reference code of the authentication request. The record in the database further includes one or more stored biometric templates for each individual. Based on the determination of the match, the method compares the biometric template of the authentication request with the stored biometric template and provides an indication to an approved destination of whether the biometric templates match, thus confirming authentic identity.

### CROSS-REFERENCE TO RELATED APPLICATIONS

This application claims the benefit of U.S. Provisional Application No. 60/840,599, filed Aug. 28, 2006, the contents of which are incorporated herein by reference.

### FIELD OF THE INVENTION

The present invention relates to a system and method for providing assurance as to the identities of individuals, and, more specifically, to a system and method for enrolling and storing different types of biometrics, preserving substantial anonymity, and for providing high-volume, rapid authentication of claims of identity. Important aspects of the invention include the preservation of anonymity of the individual participant as well as isolation of personal and private information from the authentication database and function.

### BACKGROUND OF THE INVENTION

Anonymous Recognition (herein also “AR”) and, more specifically, protection against security vulnerabilities, identity theft, and other forms of identity abuse pose significant challenges in a complex world and expanding population. A reliance on adequate individual identification is a critical ingredient in asserting or validating a personal, government, or corporate responsibility, authority for an obligation, right, or claim related to any form of public or private transaction. Although requirements for identification are common, the ability to establish and prove distinctive identity has relied on highly vulnerable methods and tools.

A highly credible technology that provides the tools and supports the methods for providing convincing proof of individual identity does exist. That technology is biometrics. Automated human identification through biometrics has enabled society to transition from unreliable and inadequate forms of personal identity validation to highly effective and accurate forms of personal recognition.

Any form of identity assurance or management that is intended to be implemented on a large scale may desirably make use of a large database. While there is no intrinsic problem in use of a centralized database of biometrics for identity management, there is, however, significant concern that the incorporation of personal data or information along with the biometric data may compromise personal privacy. The potential does exist for serious mischief and abuse if that database is also not properly constructed, controlled, and secured. Recent events involving the loss or theft of data related to personal identity and information for millions of people are examples of how not to construct and/or protect a centralized database for identity management.

Thus, there exists a need for a system that provides a centralized database of biometric templates (using different technical approaches) which is separate and distinct from personal data. There is also a need for a method for enrolling different types of biometrics in this database and for providing high-volume, high-speed authentication (using one or more matching functions) of claims of identity, while protecting the personal information of the individual. Properly designed and operated, such a system and method should create a substantially anonymous environment that protects against the threat of identity theft or invasion of privacy; thus, an “anonymous recognition” process.

### SUMMARY OF THE INVENTION

An exemplary embodiment of the present invention provides a method for enrolling an identity, in the form of a biometric template or image (Template A), in a centralized multi-modal biometric database. The method comprises receiving Template A and then performing a match function which compares Template A against templates already registered in the database. If a match occurs, the attempted enrollment of Template A is rejected as already enrolled, and the approved source making the request or other qualified or approved entity is notified. If no match occurs, Template A is accepted as an original and enrolled in the database. A coded reference number that provides an anonymous link to the enrolling individual's claimed identity is then assigned and stored with Template A. Template A is considered authenticated.

In a further exemplary embodiment of the method described above, there may, in fact, be two templates, identified herein as A-1 and A-2, submitted for initial enrollment. Template A-1 may be the product of a selected biometric technology/technique that is designated as a “universal” biometric identifier, and which will enable the entire database to be scanned for a possible match. Template A-2 may use the product of any other biometric technology/technique deemed acceptable for use by the AR system, but not designated as universal. Use of A-2 templates recognizes the need to accommodate legacy systems and special segments of the AR database. Any reference to “Template A” herein may be considered, where appropriate, to include both such A-1 and A-2 templates.

In a still further exemplary embodiment of the method for enrolling an identity described above, the method also comprises receiving an additional biometric template (Template B), which can be considered a “courier template,” from an approved external source. The method then determines whether Template B matches any “courier” biometric templates previously acquired from the “approved source” and stored in the database. If the received courier template matches a courier biometric template already stored in the database, the method then performs the match function on Template A and supplies to the external source or other qualified or approved entity the indication of whether the attempted match of Template A did, or did not, occur. If the courier template does not match any courier biometric template in the database, the attempted enrollment is denied.

Another exemplary embodiment of the present invention provides a method for authenticating an identity of a presumably enrolled individual based on a request received from that individual presenting himself or herself at a sanctioned control point or from an approved entity against a centralized multi-modal biometric database of prior enrollments. The method comprises receiving an authentication request from the sanctioned control point, point of sale, or other approved entity. The authentication request comprises a personal reference code and a biometric template presented by the individual. The method further comprises determining if any record in the database exists that comprises a personal reference code which matches the reference code presented with the authentication request. The record in the database further comprises a stored biometric template acquired at enrollment. Based on the determination of the match of reference codes, the method compares the biometric template of the authentication request presented by the individual with the stored biometric template and provides an indication of whether the biometric templates match. A match results in valid authentication, and a non-match results in an invalid authentication.

A further exemplary embodiment of the present invention provides a method for reporting the results of an authentication attempt of an identity provided by an approved inquiring entity against a centralized multi-modal biometric database. The method comprises receiving an authentication request from the approved inquiring entity. The authentication request comprises a personal reference code and a biometric template presented by the individual seeking or permitting the request for authentication. The method further comprises determining whether the inquiring identity is authorized to submit the authentication request. Based on the determination of whether the inquiring identity is authorized, the method determines if any record exists comprising a personal reference code which matches the personal reference code of the authentication request. Based on the determination of the match of personal reference codes, the method compares the biometric template of the authentication request with a biometric template of the record and provides an indication of whether the biometric templates match.

If a match of reference codes and templates is successful without anomaly or conflict, a “YES” or “Authentication Confirmed” signal is generated and sent to the requesting entity, as well as any destination approved or designated by the individual. If a match of codes and templates is not successful, a “NO” or “Authentication Denied” signal is generated and sent to the requesting entity and any destination designated by the individual. If an anomaly occurs, which is defined as a matching function that results in a false match of codes or templates, or results in a match score that is lower than acceptable for affirmation of authentication, a signal is generated that indicates that results “require investigation” and provides a description of the problem for the requesting entity and destinations designated by the individual.

In a further exemplary embodiment of the method for reporting the results of an authentication attempt, the method additionally comprises receiving from the inquiring entity a courier template. A courier template may be required depending upon a level or value of a privilege requested by the inquiring entity. The method checks the courier template against templates of authorized inquiring entities in the database to determine whether the inquiring entity is an authorized source. The method then continues with the process of authenticating the identity of the individual seeking authentication if the inquiring entity is an approved source.

### BRIEF DESCRIPTION OF THE DRAWINGS

The invention is best understood from the following detailed description when read in connection with the accompanying drawings. Included in the drawings are the following figures:

FIG. 1A is an illustration of a multi-modal database comprising a plurality of anonymous records, each for storing a plurality of biometric templates in accordance with an aspect of the present invention;

FIG. 1B is an illustration of another embodiment of the database of FIG. 1A in which bins are used to segregate anonymous records containing different types of biometric templates in accordance with an aspect of the present invention;

FIG. 2 is an illustration of an anonymous recognition system for enrolling anonymous identity-related information of an individual and for verifying a claim of identity of an individual in accordance with an aspect of the present invention;

FIG. 3 is a flow chart of exemplary steps for enrolling anonymous identity-related information of an individual in a biometric database in accordance with an aspect of the present invention; and

FIG. 4 is a flow chart of exemplary steps for authenticating a claim of identity of an individual in accordance with an aspect of the present invention.

### DETAILED DESCRIPTION OF THE INVENTION

Biometric technology, rationally and reasonably employed, offers solutions to the problem of mistaken, misused, and misappropriated identity. A large and secure database, centralized or distributed, of biometric templates provides the ability to serve a large number of government agencies, commercial enterprises, other organizations, and individuals in the function of identity management and assurance. While limited degrees of utility can be achieved by the technology in small, proprietary or localized databases, national and international requirements for commerce, infrastructure authentication, and security functions are better served in an architectural model using a large, accessible, and secure database. Because of the great number of records involved in such a large database, and the multiplicity of biometric technologies invoked, such a database is desirably designed for high-speed function and high-volume authentication of personal identity. It should also include technical defenses to “virtually” assure its uninterrupted and uncorrupted performance. Finally, it should be designed to fully isolate its content from: (1) the actual identity of the person whose encoded records are on file; (2) the actual private information related to that individual resident elsewhere; and (3) any internal threat to disclosure of identity by those who operate the database and the authentication process. The highest level of personal identity security is derived by preserving the anonymity of the enrolled persons and their records.

Arguably, biometric templates themselves are no more “private” than the public face or fingerprint of the person who supplied them. In general, a biometric template cannot be reverse engineered to produce the actual image from which it was created. It is the factual data related to that person, e.g. the person's name, Social Security number, etc., that carries the concern of exposure that should be avoided. If the database of biometric templates is electronically and physically isolated from personal information, unauthorized access to the database of templates would provide the intruder with no more than an encrypted personal reference code (described in more detail below) and biometric template without the original image and without any other understandable or useable information related to the individual.

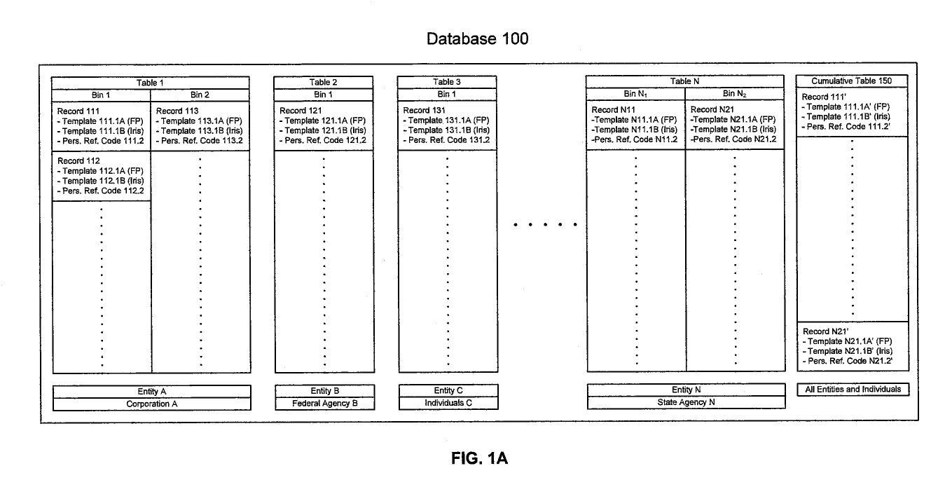

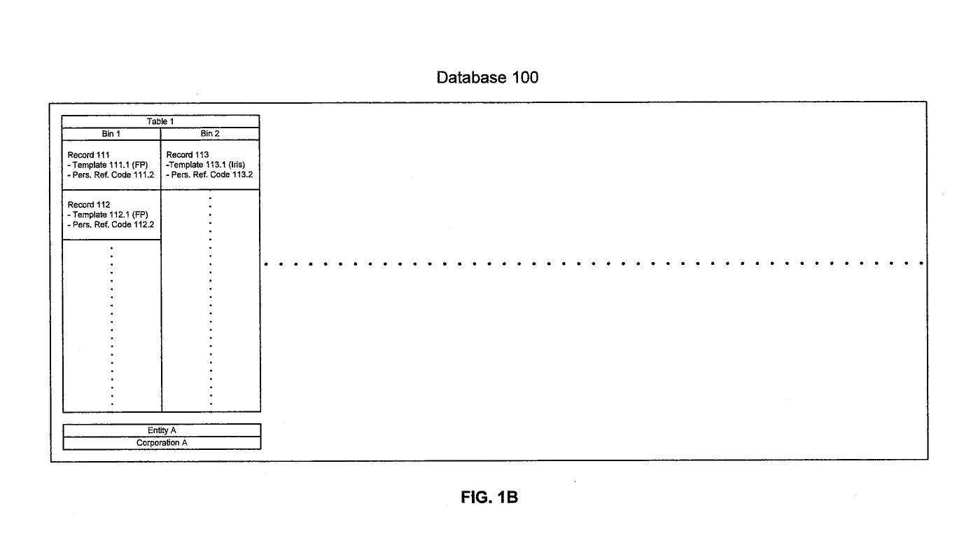

Referring now to FIG. 1A there is illustrated an exemplary embodiment of a Database 100 in accordance with an exemplary embodiment of the present invention. Database 100 includes a plurality of Tables 1, 2, 3, . . , N, each of which stores a plurality of anonymous records (personal reference codes and biometric templates) of individuals. A table may be a general list of individuals not associated with any entity (individual enrollment) or may be a list of employees of an entity or members of an organization which enrolls the records (personal references codes and templates) associated with the individuals' identities. Thus, individuals may be enrolled individually or under the auspices of an entity or organization.

For example, Table 1 includes the anonymous records for employees of Corporation A (herein also “Entity A”); Table 2 includes the anonymous records for employees of Federal Agency B (herein also “Entity B”); Table 3 includes the anonymous records for individual enrollments (herein also “Individuals C” or “Entity C”); and Table N includes the anonymous records for employees of State Agency N (herein also “Entity N”). Anonymous records are further described below.

It is appreciated that the tables in Database 100 are not limited to containing only anonymous records for employees of corporations or agencies. Each table, for example, may hold anonymous records for any individuals, agents, contractors, employees, etc. who are authorized by the entity or organization, such as Entity A, B, C, . . . , or N, for enrollment or registration in the table of the entity or organization. Furthermore, each table is not limited to enrollments with corporations or agencies but may also include enrollments with any type of entities, such as partnerships, organizations, groups, or individuals, or may also include enrollments without associations with entities, as in Table 3 (which is a group of enrollments of individuals). For purposes of the discussion below, the entity, partnership, organization, group, individual, etc. with which an individual enrolls is referred to as the “client entity.” In some instances below, the term “Group of Individuals” is used to refer to the individuals (persons) who are enrolled in Database 100 but are not associated with an entity, as in the case of Individuals C. Where appropriate, below, discussions making reference to “client entity” are applicable to “Group of Individuals.”

Each of Tables 1, 2, 3, . . , N are divided into bins which contain records with similar privileges or access authority. For example, Table 1 is divided into two bins: Bin 1 and Bin 2. Bin 1 includes all of the anonymous records for employees of Corporation A that have general access to a facility, and Bin 2 includes all of the anonymous records of employees who have a more specific type of access to the facility. It is understood that Database 100 is not limited to using Bins 1 and 2 for distinguishing between security levels for access to facilities. Bins 1 and 2 may be used for distinguishing between levels of security for any type of action that may be associated with different levels of security.

In the exemplary embodiment of Database 100 illustrated in FIG. 1A, Table 2 contains the group of anonymous records that Federal Agency B, for example, has authorized for enrollment in Table 2 and includes only one bin, Bin 1. Table 3 contains the group of anonymous records for a Group of Individuals C and includes only one bin, Bin 1. Table N is shown divided into two bins, Bins N₁ and N₂. Thus, Table N includes at least two levels of eligibility or authorization.

Although Database 100 is illustrated with N tables and a certain number of bins, Database 100 is not limited to the number of tables and bins illustrated. Database 100 may include any number of tables, and each table may include any number of bins. Furthermore, each table in Database 100 may include any number of records, each of which include the anonymous identity-related information for individuals enrolled with a client entity or a Group of Individuals, as described below.

Illustrated in FIG. 1A is a record 111 contained in Bin 1 of Table 1. Record 111 includes the anonymous identity-related information of a particular individual (not shown). The anonymous identity-related information in record 111 includes two biometric templates, a fingerprint biometric template 111.1A and an iris biometric template 111.1B, and a unique personal reference code 111.2 for the particular individual. In an exemplary embodiment, templates 111.1A and 111.1B and personal reference code 111.2 are encrypted to enhance the security of Database 100. Biometric templates 111.1A and 111.1B are based on biometric features of the particular individual using a specified biometric technique/technology. For example, biometric template 111.1A is a fingerprint template based on a fingerprint of the particular individual, and biometric template 111.1B is a template from the same individual using iris recognition.

In a further exemplary embodiment of Database 100, template 111.1A may be the product of a selected biometric technology/technique that is designated as a “universal” biometric identifier, and template 111.1B may use the product of any other biometric technology/technique deemed acceptable for use in Database 100, but not designated as universal. Use of such a template 111.1B recognizes the need to accommodate legacy systems and special segments of Database 100. It is understood that any reference to biometric templates, herein, is relevant to such templates being either universal biometric identifiers or the product of such other biometric technology/technique.

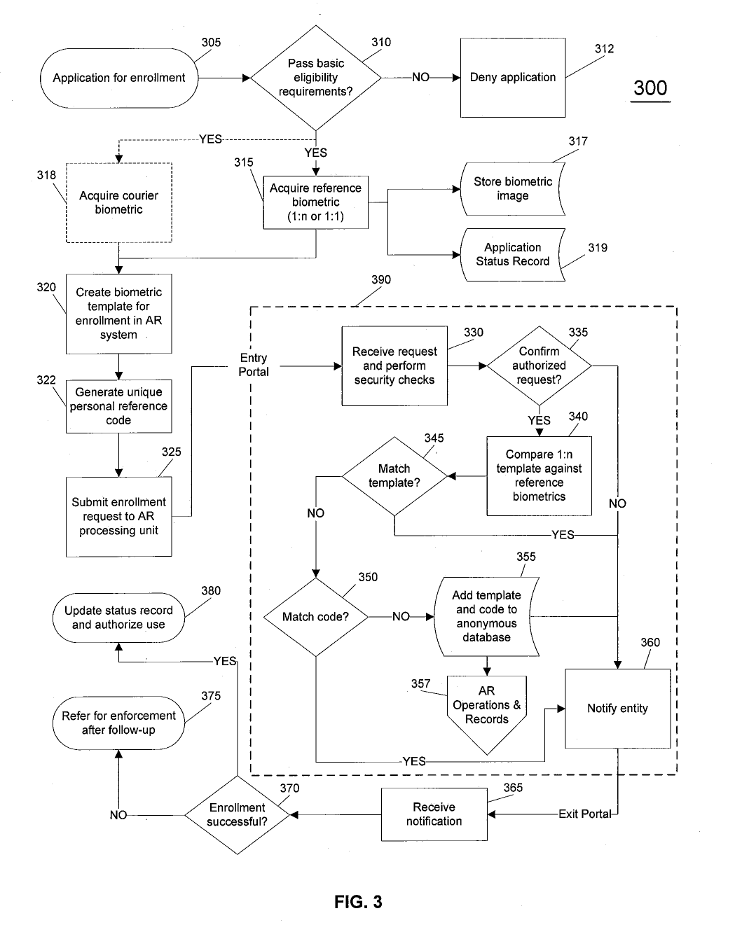

Continuing in FIG. 1, personal reference code 111.2 is an alphanumeric encrypted code or one-way hash that is substantially unique to the enrolled individual corresponding to record 111 such that no two records in different tables in Database 100 have identical personal reference codes. Thus, the personal reference code also supports an individual's uniqueness (within the context of the database), as in the case of the template, but does not provide sufficient information to discern who the individual really is. An example of the personal reference code and how it is formed is provided below in the discussion of FIG. 3.

Database 100 substantially preserves the anonymity of enrolled individuals because the templates in Database 100, such as template 111.1A, and the personal reference codes, such as personal reference code 111.2, contain no discernable link to the actual identity (full name, Social Security number, etc.) of the individual or to data that can be linked to that identity. The actual identity of an individual cannot be reverse engineered using only information available within Database 100 because the templates and personal reference codes do not allow one to discern the name, Social Security number, etc. of the individual. Thus, because record 111 includes biometric templates 111.1A and 111.1B and personal reference code 111.2 and does not include information that allows one to reverse engineer an individual's actual identity, Database 100 and the records contained therein are said to be “substantially anonymous.”

The biometric templates and personal reference codes stored within Database 100 are referred to herein as “anonymous identity-related information” because they relate to an individual's identity without revealing that individual's actual identity. More specifically, the biometric template that forms part of the anonymous identity-related information relates to an individual's identity in that it is based on a feature of the individual. The template and the personal reference code are unique to the individual and distinguish the record that contains them from other records that contain templates or personal reference codes of other individuals. The biometric template and personal reference code do not, however, allow a third party to identify the individual's actual identity, i.e., to ascertain the individual's name, Social Security number, etc. or to reconstruct a physical feature of the individual. Thus, the template and the personal reference code support the anonymity of the individual, hence making them “anonymous identity-related information.” It is understood that “anonymous identity-related information” is not limited to biometric templates and personal reference codes but includes any information that uniquely identifies an individual without identifying the individual's actual identity.

Also shown in Table 1, is a record 112 in Bin 1 and a record 113 in Bin 2, both of which respectively include other templates 112.1A and 112.1B and 113.1A and 113.1B and personal reference codes 112.2 and 113.2 related to individuals in the database. These biometric templates and personal reference codes of these records are constructed, maintained, and used similarly to templates 111.1A and 111.1B and personal reference code 111.2 of record 111. The dotted lines below records 112 and 113 indicate that Bins 1 and 2 of Table 1 may include any number of anonymous records for individuals.

Also illustrated in FIG. 1A is a record 121 in Bin 1 of Table 2 containing a fingerprint template 121.1A, an iris template 121.1B, and a personal reference code 121.2; a record 131 in Bin 1 of Table 3 containing a fingerprint template 131.1A, an iris template 131.1B, and a personal reference code 131.2; a record N11 in Bin N₁ of Table N containing a fingerprint template N11.1A, an iris template N11.1B, and a personal reference code N11.2; and a record N21 in Bin N₂ of Table N containing a fingerprint template N21.1A, an iris template N21.1B, and a personal reference code N21.2. The dotted lines below the records in Tables 2, 3, and N indicate that these tables may include any number of anonymous records of individuals. There is no theoretical limit to the number of individuals whose anonymous records may be stored in Database 100.

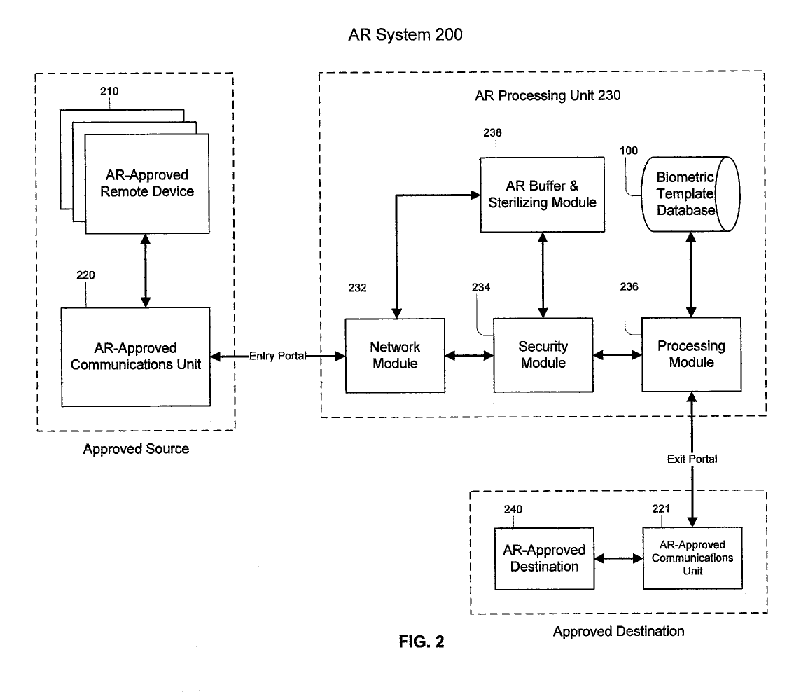

Also included in each biometric template in each record of Tables 1, 2, 3, . . . , N is a suffix which identifies the type of the associated biometric template. The type of the biometric template indicates what biometric technology or technique was used to capture the biometric template. For example, a biometric template 111.1A includes both a fingerprint biometric template as well as a suffix that indicates that the biometric template is a fingerprint type, and biometric template 111.1B includes both an iris biometric template as well as a suffix that indicates that the biometric template is an iris type. Thus, one may think of the reference number “111.1” as referring to the biometric template and the reference letter “A” as referring to the suffix. In this way, the reference “111.1A” indicates a fingerprint biometric template with a fingerprint suffix appended to it. Database 100 supports the enrollment (storage) of any type of biometric template known in the art within a range of those specified as compatible for use in the anonymous recognition system described below with relation to FIG. 2.

Although the fingerprint and iris suffixes may be appended to biometric templates enrolled in Database 100, in a further exemplary embodiment of Database 100, the suffixes appended to templates 111.1A and 111.1B are stored as separate fields (not shown) in record 111. In another exemplary embodiment of Database 100, prefixes are used instead of suffixes, in which case the prefixes may be stored as separate fields in record 111 or may be affixed to the beginning of biometric templates 111.1A and 111.1B. In yet another exemplary embodiment of Database 100, an identifying code is embedded within templates 111.1A and 111.1B and need not be attached as a prefix or suffix. It is understood that any discussions herein relating to suffixes and their use within Database 100 are applicable to embodiments of Database 100 that include prefixes, embedded identification codes, or separate fields of identification codes.

In an exemplary embodiment, Database 100 includes a table 150 of substantially anonymous cumulative enrollments which are copies of all records that are stored in Database 100. Thus, in this embodiment, anonymous records for each enrolled individual are stored in two different areas: in the table authorized by the client entity or the Group of Individuals and in cumulative table 150. In FIG. 1A, copies of records 111 through N21 are stored in cumulative table 150 as records 111′ through N21′. Templates 111.1A′ and 111.1B′ and personal reference code 111.2′ are respectively copies of templates 111.1A and 111.1B and personal reference code 111.2. Templates N21.1A′ and N21.1B′ and personal reference code N21.2′ are respectively copies of templates N21.1A and N21.1B and personal reference code N21.2.

Cumulative table 150, which may be further organized into subtables to accommodate different modalities, is used to anonymously compare any possible new enrollment against all other records already stored in Database 100 to ensure that the anonymous identity-related information provided in the new enrollment is not fraudulent, i.e., that a potential user is not posing as someone else to gain authorization to access a facility or system. Substantially anonymous enrollment of an identity of an individual is described in detail below in the description of FIG. 3.

FIG. 1B illustrates another embodiment of Database 100, in which biometrics of different types are stored within records in different bins in Tables 1, 2, 3, . . . , N. As is evident in the illustration of Table 1 in FIG. 1B, record 111 includes only one type of biometric template, template 111.1, which is a fingerprint biometric template, and record 112 also includes only one type of biometric template, template 112.1, which is also a fingerprint biometric template. Both records 111 and 112 are stored in Bin 1 of Table 1 and respectively include personal reference codes 111.2 and 112.2. Included in Bin 2 is a record 113 which includes only one biometric template 113.1, which is an iris biometric template. Record 113 also includes a personal reference code 113.2. In the embodiment of Database 100 illustrated in FIG. 1B, prefixes, suffixes, or embedded identification codes are not required to identify the types of the enrolled biometric templates as the biometric templates are segregated into different bins, although the use of prefixes, etc., is not foreclosed. The embodiment of Database 100 illustrated in FIG. 1B may include any of the tables of the embodiment of Database illustrated in FIG. 1A.

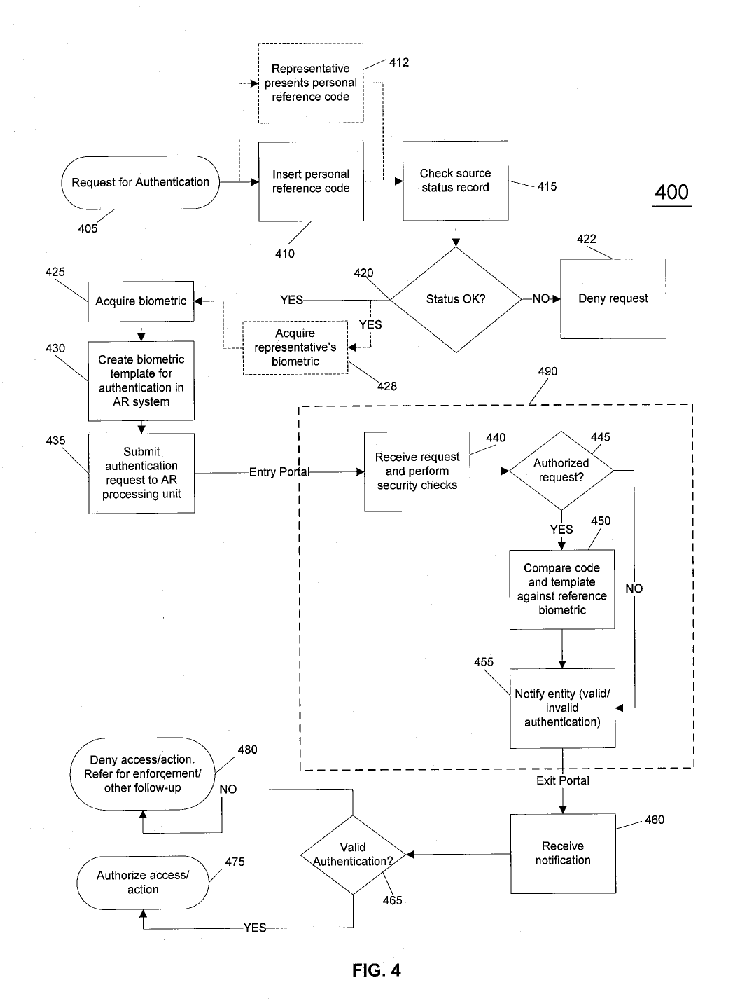

Referring now to FIG. 2, there is illustrated an exemplary embodiment of anonymous recognition (which may also be referred to herein as “AR”) system 200 in accordance with an exemplary embodiment of the present invention. AR system 200 includes three primary components: (1) a first external component or subsystem that includes both an AR-approved remote device 210 and an AR-approved communications unit 220 at the enrollment/presentation source; (2) a second external component or subsystem that includes both an AR-approved destination 240 and an AR-approved communications unit 221; and (3) an internal component or subsystem that is the AR processing unit 230. AR system 200 uses these components to authenticate identities of individuals by receiving and processing anonymous records in enrollment/presentation requests (also called “registration requests”) and by verifying identity records, or claims of identity, in authentication requests. A process for receiving and processing enrollment requests is described in greater detail below in relation to FIG. 3, and a process for authenticating anonymous records is described in greater detail below in relation to FIG. 4.

AR system 200 may be used in any environment requiring any event requests to be verified. Events or requests include any of banking, consumer, corporate, or government transactions; requests for entry to a facility; requests to receive entitlements; health insurance verification; access to health or other records; etc.

Now AR system 200 and its constituent components illustrated in FIG. 2 are described. The embodiment of AR system 200 illustrated in FIG. 2 includes separate approved source and approved destination components and relevant subcomponents. In other embodiments, the approved source is the same as the approved destination such that AR-approved remote device 210 and AR-approved destination 240 are the same and AR-approved communications unit 220 and AR-approved communications unit 221 are the same. Note that the database architecture discussed in this embodiment may be altered to achieve increased efficiency in performance.

### AR-Approved Remote Device 210

AR-approved remote device 210 includes a biometric acquisition device, such as an iris imager, fingerprint scanner, camera, voice recording device, etc., and associated processing circuitry that has been approved for use with the AR system. Remote device 210 is configured to capture a biometric (iris, fingerprint, face, hand, voice, signature, etc.) of a live individual, encode the biometric into a biometric template, encrypt the biometric template, and send the biometric template with other information via AR-approved communications unit 220 to AR processing unit 230 as part of a request, such as an initial enrollment request or a request for authentication. As is illustrated in FIG. 2, remote device 210 and communications unit 220 are external to processing unit 230.

A request may take on one of two forms: an enrollment request in which submitted anonymous identity-related information is to be stored in an individual's or a client entity's table or an authentication request in which a submitted biometric template is to be verified as being enrolled. These requests and other information included in the requests are described in greater detail below with reference to FIGS. 3 and 4.

In a preferred embodiment, to maintain a secure system and prevent unauthorized access, AR system 200 includes security features that allow only specially processed individuals or client entities to enroll identities in AR system 200. At a minimum, the validity of the request may be ascertained by checking the MAC and/or IP addresses of the biometric acquisition device submitting the enrollment request. Then, processing unit 230 only accepts requests from remote devices with an approved source MAC and/or IP addresses that it recognizes as belonging to the Group of Individuals or client entity from which the request purports to originate. Alternatively, (or additionally), the validity of the request may be ascertained by checking a courier template submitted by the Group of Individuals or the client entity. Then, processing unit 230 only accepts requests from remote devices from which a recognized courier template was received.

Many of the features included in the AR process are designed to thwart attempts at fraudulent as well as inadvertent multiple enrollments unless such enrollments are a deliberate and permitted action under the operating performance rules of the AR system. An example of a permitted multiple enrollment occurs when the same individual is associated with more than one client entity, and all such client entities are apprised of the condition and approve. Such enrollments will be appropriately “tagged” by the system. The design of AR system 200 will accommodate biometrics that only function in the 1:1 match environment as well as those that are capable of 1:n (one to many) operation.

At the present time, fingerprint and iris recognition are the preferred technologies for enrollment into Database 100 in order to fully support performance of 1:n searches of Database 100. 1:n search capability is highly preferable for initial registration (enrollment) because of the improved capability for fraud detection. To only a slightly lesser extent, the 1:n search capability is also preferred for real-time authentication for any purpose or application for the same reason. Therefore, in a preferred embodiment, remote device 210 is either a fingerprint scanner or an iris recognition device. However, the design of AR system 200 does accommodate biometrics that only function in the 1:1 match environment.

Remote device 210 may be connected to an Ethernet switch on a local area network (LAN) which, in turn, is connected through a secure router in AR-approved communications unit 220 to processing unit 230. Alternative embodiments of communications unit 220 are described below.

The actual performance of remote device 210 is an important factor in the effectiveness of AR system 200. Poor quality biometric images and templates can dramatically affect the reliability of enrollment and identity authentication operations in AR system 200. The quality of the biometric image or template being captured and submitted to processing unit 230 directly affects the cost, reliability, and value of AR system 200 as a whole.

Image quality can be affected by the biometric acquisition device itself (sensor resolution, template encryption algorithm, ease of use, etc.), by the operational procedures for using the biometric acquisition device (proper use and reliable training), and by the system with which the biometric acquisition device is used (in this case, AR system 200). Hence, setting a minimum performance requirement or AR compatibility specification for remote device 210, itself, as well as on AR system 200, as a whole, is important to ensure the success of biometric enrollment and identity verification. A number of commercially available biometric devices will be capable of meeting the operation specification for AR system 200.

The interface for enrolling users within AR system 200 may be a commercial, off-the-shelf component that has been rigorously tested and refined through extensive field deployments. Additionally, remote device 210 desirably includes software that conforms the output of remote device 210 to processing unit 230, through the AR-approved communications unit, device 220. This software in remote device 210 desirably runs on both Microsoft and UNIX platforms.

### AR-Approved Destination 240

Also illustrated in FIG. 2 is an AR-approved destination 240 that utilizes an AR-approved communications unit 221 to receive system reports. System reports include notifications of successful/unsuccessful enrollment requests and authentication requests. Destination 240 may be a facility to which an individual has requested access or may be a company or governmental agency for which a specific action was requested. Additionally, destination 240 may be any destination which is approved by AR system 200 to receive system reports. As mentioned above, destination 240 may be at the same location as remote device 210.

### AR-Approved Communications Units 220 and 221

AR-approved communications units 220 and 221 are the communications pathways, links, lines, etc. by which remote device 210 communicates with processing unit 230 and by which processing unit 230 communicates with destination 240. Although communications units 220 and 221 are presented as units in the architectural layout of AR system 200, they may be any communication pathways, links, lines, etc. that are between two physical locations, namely between remote device 210 and processing unit 230 and between processing unit 230 and destination 240, and that meet the operating specifications for AR system 200. As mentioned above, AR-approved communications units 220 and 221 may be the same or different communications pathways, links, lines, etc.

Examples of possible embodiments of communications units 220 and 221 include the following:
Secure, encrypted connection via the Internet;
Dedicated high speed connection between the client entity's WAN and processing unit 230;
High speed frame relay connection between the client entity's multiple LANs and processing unit 230;
Dial up connection to processing unit 230 via ISDN; and
Satellite connection between the client entity's LANs, WAN, and processing unit 230.
   For better security and total network redundancy, processing unit 230 may be connected to the Internet using a Border Gateway Protocol, such as BGP4, in addition to network security equipment and applications that protect and monitor biometric template Database 100.

### AR Processing Unit 230

AR processing unit 230 includes a combination of networking, computational, and biometric hardware, software, and middleware which allows AR system 200 to accept and process template registration and authentication requests from biometric acquisition devices, such as remote device 210. Additionally, this hardware, software, and middleware allow processing unit 230 to accept and process template registration requests from individuals and client entities via communications unit 220.

AR processing unit 230 accurately identifies or verifies and matches reference codes and biometric templates submitted by client entities against records in biometric Database 100, logs all processed activities, generates auditable reports on a predefined schedule, communicates with other authenticated IP sources through multi-layer security firewalls, and includes fail safe measures to overcome any one single point of failure. Additionally, AR processing unit 230 handles multiple modalities and processes requests in either single-mode or multimodal modes using biometric template Database 100.

After receiving a request from an individual or a client entity, processing unit 230 decrypts, decodes, and automatically extracts template features from biometric templates submitted with the request. Depending on the type of the request, processing unit 230 compares and processes the received biometric template in 1:1 and/or 1:n searches. For a distributed database, processing unit 230 handles distributed computations and control algorithms.

AR system 200 includes a number of measures that defend the system from attack and maintain continued operations through a catastrophe. As described above, processing unit 230 only accepts requests from authorized client entities and individuals. Other defensive measures in processing unit 230 include firewalls, physical connection/disconnection switches, sterilization processes, and authentication of a submitting source's representative's biometric feature (the courier template). An important attribute of communications unit 220 and processing unit 230 is redundancy. For this reason, it is important to consider having two physical locations that are dedicated for processing unit 230, with duplicate systems that backup each other. AR system 200 is desirably able to switch to a redundant system based on a set of rules implemented within processing unit 230 in order to maintain catastrophic survivability. Such rules include, but are not limited to, the following: power failure without UPS recovery; failure to respond to system requests; failure in database operations; and output failures.

Although processing unit 230 is indicated as a unit in FIG. 2, it may be a distributed system, with components located at a plurality of locations. Processing unit 230 should include such features as bandwidth bursts for momentary spikes in communications; a secured network that is constantly monitored for any type of intrusion; the capability to offer adequate uninterrupted and redundant AC and DC power supply; computerized, redundant and monitored cooling/heating systems; state-of-the-art fire-prevention and fire-suppression systems that are designed for computer equipment; adequate redundancy and remote backup of critical data; and competent technical assistance and support.

### Receiving and Processing Requests in AR System 200

Remote device 210 issues requests to processing unit 230. A request may take on two forms, each of which is now described in more detail.

A first form is a request for enrollment or registration of anonymous identity-related information of an unassociated individual or of an individual member of a client entity, such as a company, organization, group, individual, etc. Following the scanning of an individual's biometric, remote device 210 submits the biometric template via communications unit 220 as part of an enrollment request. In such a request, remote device 210, which is typically under control of an administrator at the client entity's facility or special registration kiosk, sends the encrypted biometric template with a proposed personal reference code to processing unit 230 for enrollment in biometric Database 100. The enrollment request seeks first to have the biometric template and personal reference code compared to all templates and codes already stored in AR Database 100. If no match is found, or if a match is found but not resolved (individual is properly registered under more than one entity/group), the anonymous record (template and code) will be stored in a bin and table associated with the client entity or Group of Individuals. Because a request for enrollment includes a biometric template and a personal reference code, as understood herein, the request is substantially anonymous. The method for forming the unique personal reference code is described below.

A second form is a request for authentication of a claim of identity of an individual. Following the scanning of the individual's biometric, remote device 210, which is typically under control of a client entity or administrator, submits the biometric template as part of an authentication request. In such a request, a personal reference code accompanies the biometric template to processing unit 230. The authentication request seeks from AR processing unit 230 an indication of whether the biometric template and code matches an enrolled anonymous record in Database 100. Because a request for authentication includes a biometric template and a personal reference code, the request is substantially anonymous.

Reception and processing of requests in processing unit 230 is now described. A request submitted by remote device 210 through communications unit 220 is received by networking module 232 which passes it to security module 234. Security module 234 verifies whether the inquiring source is an approved administrator or a client entity that is authorized to submit the request. In an exemplary embodiment of AR system 200, security module 234 checks a previously recorded biometric template of the administrator or client entity against a courier template submitted by the client entity or checks the IP and/or MAC addresses of the inquiring source. If security module 234 recognizes the courier template or the IP and/or MAC addresses, processing unit 230 determines that the inquiring source is an administrator or a client entity authorized to submit requests.

After security module 234 verifies that the request came from an authorized source, the request is passed to AR buffer and sterilizing module 238 which checks the request for viruses and/or malicious software. After the security checks are complete, processing module 236 processes the received request according to whether the request is for enrollment or verification of an identity. In a further exemplary embodiment of AR system 200, AR buffer and sterilizing module 238 checks the request for viruses and/or malicious software before security module 234 determines whether the request came from an authorized source.

Continuing in FIG. 2, for enrollment requests, processing module 236 determines whether the received biometric template is already registered/enrolled in Database 100. Module 236 contains the multi-modal biometric matching engine. If the received biometric template is not already registered in Database 100, processing module 236 stores the received anonymous identity-related information (including the personal reference code) in a newly created record, such as record 111, in biometric template Database 100. Processing module 236 also identifies the type of the biometric template included in the request, generates the proper suffix, and includes the suffix in the newly created record. In appropriate embodiments, as when the Database 100 of FIG. 1B is used, processing module 236 may store the biometric template without a suffix.

After processing module 236 accepts or rejects the enrollment request, processing unit 230 returns a response to an approved destination, such as approved destination 240, via communications unit 221. The response indicates the success or failure of enrolling the submitted identity record in Database 100. The process of enrolling an identity is described in more detail below in relation to FIG. 3.

As described above, authentication requests contain anonymous identity-related information which includes a biometric template of an individual and a unique personal reference code for the individual. After processing unit 230 receives an authentication request and performs the necessary security and authorization checks, processing module 236 identifies the record in Database 100 that includes a unique personal reference code that is identical to the personal reference code received in the authentication request, if such a record exists. If processing module 236 identifies a record with the appropriate personal reference code, processing module 236 compares the received biometric template against the biometric template stored in the record to verify the identity of the acquired biometric. If the biometric templates match, processing unit 230 returns a response to AR-approved destination 240 via communications unit 221. The response indicates that the received identity record is valid. If either the codes or the templates do not match, a non-valid report is issued. The process of authenticating a claim of identity is described in more detail below in relation to FIG. 4.

AR system 200 has the potential to eliminate security weaknesses that enable identity theft and security vulnerabilities. The advantages that AR system 200 provides are substantial. AR system 200 minimizes the resources required for an organization to implement biometric technology within its premises. Using AR system 200, an organization will save on financial, technical and human resources that would have been required to implement, operate, and support an independent biometric authentication system. These resources would otherwise have to be dedicated to system acquisition, installation, maintenance, support, training, help-desk operations, and upgrades. As an AR participant or subscriber, an organization will benefit from a secure, well-established and properly managed biometric infrastructure that allows it to exploit this technology to the fullest while saving on unnecessary expenses in equipment, personnel, and outside consultations. None of the management or operating personnel of AR system 200 will have access to any private information related to any individual in the database since no such information is contained in the database, i.e. the database is substantially anonymous.

AR system 200 provides protection against individual identity theft on national and international levels. Through its centralized access and with a template numbering scheme that contains only a personal reference code that does not reveal an individual's identity or any other related private information, AR users are effectively protected from identity theft resulting from their participation in this process. AR users are not required to provide any critical personal information to participate in the AR system 200. Consequently, the risk of having an identity stolen is reduced dramatically, and participation in such a system greatly increases the odds of deterring or exposing security threats on national and international levels.

In the unlikely event that biometric templates or reference codes are corrupted or stolen from the database during the registration or authentication process, usefulness of such theft is greatly reduced if not eliminated by the required participation of both the individual for live presentation and an approved source for initiating inquiries for any subsequent transaction. Changes in reference codes or templates immediately upon detection of any intrusion would further render such theft useless.

FIG. 3 depicts a flow chart 300 of exemplary steps for enrolling anonymous records of an individual with a client entity in Database 100 using AR system 200 in a substantially anonymous process. Enrollment in Database 100 is the process by which an anonymous record is created for the individual, populated with anonymous identity-related information that maintains the anonymity of the individual while identifying the uniqueness of the individual, stored in Database 100, and associated with a client entity. In a preferred embodiment, only a client entity or an authorized individual may submit enrollment requests to processing unit 230. The steps set forth in FIG. 3 are described with reference to FIG. 2. Reference number 390 denotes those portions of the flowchart that are executed in AR processing unit 230.

Although the description below relates to registering anonymous identity-related information and authenticating the identities of individuals (persons), it is understood that the description is also applicable to registering identity-related records and authenticating the identities of animals, such as horses, cats, dogs, cattle, etc. In this application, anonymity is, presumably, not an issue.

Enrollment begins in Step 305 in which an individual applies for enrollment through an administrator or with a client entity in AR system 200. An application for enrollment may be prompted by a need for access to a secure facility or system of a company; authority to process high value transactions; or eligibility for some privilege or approval authority. In this example, the enrolling individual is an employee of a company with which the individual is enrolling, i.e. the company is the client entity. It is understood that the procedure illustrated in flowchart 300 is not limited to enrolling an identity of an employee with a company, but may be used for enrolling an identity of any individual with any client entity or Group of Individuals.

In Step 310, the company (client entity) performs its basic eligibility requirements to determine whether the employee may apply for enrollment. These checks for basic eligibility requirements are typically made on-site at the company's facilities. If the company determines that the enrolling employee's passes its basic eligibility requirements, Step 315 is performed. Otherwise, the company denies the application in Step 312. In Step 315, the enrolling employee presents his or her biometric to an acquisition device, such as remote device 210, which scans or otherwise images the biometric feature and creates a template. In Step 317, the biometric template is stored in a database maintained by the company.

In an exemplary embodiment, the company (client entity) maintains a log of activities of biometric device 210. Such a log might be a database of status records, where each status record belongs to an employee of the company and includes information relating to the status of the employee's enrollment in Database 100. A status record may include an indication that an employee is enrolled in Database 100, that a request for enrollment has been made, or that an employee's application for enrollment in Database 100 has been denied. The status records are stored in a database maintained by the company separate from Database 100. In Step 319, the status record for the employee applying in Step 305 is updated to indicate that the employee has applied for enrollment/registration for a specific work-related requirement.

In Step 320, the acquired biometric image is converted into a biometric template and encrypted. In the enrollment/registration process or presentation process a unique personal reference code is generated in Step 322 using a proprietary formula. This personal reference code may contain various pieces of information, such as an alphanumeric indicator of the type of biometric, some digits of the employee's number from his or her passport or other common document, the employee's month and day of birth, an abbreviation for the employee's country of birth or current residence, and other distinguishing alphanumerics. An example of the unique personal reference code could be A-5555-0101-US-XXXX. Each of the portions of this sample code are described below:
“A”: identification for a fingerprint template;
“5555”: as extracted from the employee's passport
“0101”: Month and day of birth date of the employee;
“US”: Country of Birth and residence of the employee; and
“XXXX”: as extracted from other documentation belonging to the employee.
   As can be seen, the unique personal reference code does not reveal the identity or useful personal information, such as name, Social Security number, etc., of the enrolling individual, but it does distinguish that individual from other enrolled individuals because the personal reference code is substantially unique to that subscriber/enrollee. By using biometric templates and personal reference codes, AR system 200 distinguishes among enrolled individuals, while maintaining the anonymity of the database. This process may be enhanced by a one way hash of the reference code to further assure the anonymity of the participant.

In Step 325 the scanned biometric template and personal reference code are submitted by remote device 210 to AR processing unit 230 over a secure communication link, such as communications unit 220, through the entry portal as an enrollment request.

Networking module 232 receives the enrollment request in Step 330 and passes the request to AR buffer & sterilizing module 238 which performs security checks, such as checking for viruses and/or malicious code in the enrollment request. Module 238 also decrypts the biometric template if necessary. Next, in Step 335, security module 234 determines whether the enrollment request is an authorized request, i.e. whether the company submitting the enrollment request is a client entity or administrator that is authorized to submit the request. If security module 234 determines that the submitting device does not belong to a client entity, then processing unit 230 refuses to execute the enrollment request and, in Step 360, notifies the requesting company of the failed attempt at enrollment.

If the company is an authorized client entity, processing continues to Step 340, in which processing module 236 compares the biometric template received in the enrollment request against reference biometric templates in Database 100. In the embodiment of Database 100 that does not include cumulative table 150, in Step 340 processing module 236 compares the received biometric template against all templates in the records stored in Tables 1, . . . , N of Database 100 to determine whether any record already in Database 100 has the same or similar (within a predetermined margin of error) biometric template as the received biometric template. In the embodiment of Database 100 that does include cumulative table 150, in Step 340 processing module 236 compares the received biometric template against all templates in the records stored in cumulative table 150 to identify whether the employee has already been enrolled. 1:n search algorithms are employed in Step 340. For purposes of discussion below, the set of records in Tables 1, . . . , N or in cumulative table 150 against which processing module 236 compares the received biometric template is referred to as the “Search Set.”

Because Database 100 may include biometric templates for any modality of biometric, comparing the received biometric template against a biometric template of a different type may lengthen the search time and produce unpredictable results. It is desirable that processing module 236 limit the comparison of the received biometric template to biometric templates in the Search Set having like types.

In an exemplary embodiment, in Step 340 processing module 236 only compares the received biometric template against those biometric templates in the Search Set that have the same type as the received biometric template. In the embodiment in which the records of Database 100 include suffixes and the received enrollment request includes such a suffix, processing module 236 only compares the received biometric template against biometric templates in the Search Set that have suffixes that are identical to the received suffix. In the embodiment in which the received enrollment request does not include a suffix, processing module 236 analyzes the received biometric template to determine its type and only compares the received biometric template with biometric templates in the Search Set that have the same type. Thus, processing module 236 only compares received biometric templates against like biometric templates stored in Database 100.

For example, if the received enrollment request includes a fingerprint biometric template and a suffix “A” that indicates such, processing module 236 will compare the received fingerprint biometric template against only biometric templates in the Search Set that have “A” suffixes. If the received enrollment request includes a fingerprint biometric template and no suffix, processing module 236 will identify the received biometric template as a fingerprint template and compares it to only those biometric templates in the Search Set that are fingerprint templates.

If processing unit 230 determines in Step 345 that a match was found during the comparison in Step 340, in Step 360 networking module 232 notifies the company that sent the enrollment request that the enrollment request could not be completed because of the duplicate enrollment. Thus, the enrollment request is denied and the received biometric template is not stored into Database 100.

If processing unit 230 identifies no prior enrollment of the template, an attempt to match the received personal reference code at Step 350 to a stored personal reference code in Database 100 is made. If not successful, i.e. if no fraudulently duplicative match is found, the received personal reference code and biometric template are entered into Database 100 at Step 355 as a new enrollment, as discussed below. If a match of personal reference codes is made, however, the enrollment will be rejected and the entity at Step 360 will be notified.

In Step 355, processing module 236 identifies the table, Table 1, . . . N, in which the submitted biometric template is to be stored, i.e. processing module 236 identifies the table belonging to the company that submitted the enrollment request. If appropriate, processing module 236 identifies the proper bin (Bin 1 or Bin 2) for the received biometric template. Once identified, in Step 355, processing module 236 creates a new record in the identified table or bin and stores the received biometric template and the received personal reference code. Step 355 may also store a suffix (if used) in fields in the newly created record or may append it to the stored biometric template. If the embodiment of Database 100 includes cumulative table 150, a copy of the newly created record is stored in cumulative table 150 as part of Step 355. (For AR system 200 to operate as intended, when the employee is no longer associated with the company, his or her template will desirably be erased from the company's table of templates per its privacy policy but not from the table of cumulative records.) A record of the transaction is created and stored by AR System 200 in a database separate from Database 100 in Step 357.

After the identity-related information is successfully enrolled, in Step 360 processing unit 230 sends a response via communications unit 221 to approved source 240 indicating that the enrollment request was successful. In Step 365, approved source 240 receives notification of the success or failure of enrolling the employee in Database 100. If it is determined in Step 370 that enrollment was successful, in Step 380 an indication of the success of the enrollment is stored in the company's status record for the employee, and the employee is authorized the function or privilege that prompted the request for enrollment. If it is determined in Step 370 that the enrollment was denied, in Step 375 the company denies the employee the authorization or privilege sought, but may consider allowing the employee to try to enroll again after examining the possible reasons for failure.

An exemplary embodiment using courier templates (also referred to as “carrier” or “escort templates”) is now described. In Step 318, an authorized agent, administrator, or representative of the company presents his or her biometric for template evaluation with his or her personal reference code, in addition to the employee's biometric, as previously described. In Step 320, this representative's or administrator's biometric is converted to a template and submitted with the administrator's template accompanies the employee's template in Step 325, it is referred to as a “courier template.” In the check for authorization in Step 335, the identity of the courier template is verified using the processes described below in method 400 for authenticating identity. If processing module 236 determines that the courier template is enrolled and authorized, the enrollment request is considered an authorized request, and the employee's template is analyzed in Step 345 to determine whether it is already enrolled. Otherwise, the company is notified in Step 360 of the unauthorized enrollment request. It is appreciated that courier templates are not limited to representatives or administrators of companies, but may be from any individual authorized by the company, organization, group, etc. to submit authentication and enrollment requests.

In another exemplary embodiment, in Step 335 module 234 analyzes IP and/or MAC addresses acquired from biometric device 210 with the enrollment request. If module 234 recognizes these addresses as coming from an authorized source, processing of the enrollment request continues in step 340. Otherwise, the company is notified in Step 360 of the unauthorized enrollment request.

In yet another exemplary embodiment, authorized representatives or agents of client entities have their identities (courier templates) separately enrolled in a client entity's table or bin using method 300. The use of these enrollments during identity authentication is described in relation to FIG. 4.

FIG. 4 depicts a flow chart 400 of exemplary steps for authenticating an individual's identity (or claim of identity) using AR system 200 in a substantially anonymous process. In a preferred embodiment, only a client entity may submit requests for processing unit 230 to authenticate the individual's identity. Reference number 490 denotes those portions of the flowchart that are executed in AR processing unit 230. It is understood that the procedure illustrated in flowchart 400 is not limited to authenticating an identity of an employee of a company, but may be used for authenticating the identity of any individual with any client entity or Group of Individuals. The steps set forth in FIG. 4 are described with reference to FIG. 2.

The process of authentication verification begins in Step 405 in which a purported employee of a company requests his or her identity be authenticated by AR system 200. The individual's personal reference code is acquired in Step 410 through a card swipe, RFID tag, or other specified action.

In Step 415, the company checks the status record of the purported employee applying for access to a secure facility or system (or other purpose) to determine whether the status record indicates that the individual is enrolled in AR system 200, i.e. that the individual is an employee authorized to access the secure facility or system. If the company determines in Step 420 that the employee's status record does not indicate that the employee is enrolled in Database 100, then the company denies the employee's request for access in Step 422. Alternatively, if the company determines in Step 420 that the status record does indicate that the employee is enrolled in Database 100, then the process of authentication continues to Step 425. Thus, the status record, which is maintained by the company separately from Database 100, provides a first layer of security.

In Step 425, the individual presents his or her biometric feature to an acquisition device, such as remote device 210, which scans the presented feature of the individual and captures an image of the biometric. In Step 430, the acquired biometric image is converted into a biometric template and encrypted in remote device 210. In Step 435 the scanned biometric template is submitted by remote device 210 to AR processing unit 230 via communications unit 220, as an authentication request.

Networking module 232 receives the authentication request in Step 440 via the entry portal and passes the request to AR buffer & sterilizing module 238 which performs security checks, such as checking for viruses and/or malicious code in the enrollment request, and decrypts the biometric template if necessary. Next, in Step 445, security module 234 determines whether the authentication request is an authorized request, i.e. whether the company submitting the authentication request is a client entity or an administrator that is authorized to submit the request. If the company or administrator/individual submitting the authentication request is not an authorized client entity, then processing unit 230 refuses to verify the submitted identity and, in Step 455, notifies the company for which authentication was requested of the unauthorized request.

If the company is an authorized client entity, processing continues to Step 450, in which processing module 236 identifies a reference biometric template in Database 100 and compares the biometric template received in the authentication request against the stored biometric template. 1:1 search algorithms are employed in Step 450.

More specifically, in Step 450, processing module 236 identifies the stored biometric template by locating the record in Database 100 with the personal reference code that matches the personal reference code submitted with the authentication request. Because the request is submitted by the company, processing module 236 only searches the company's (client entity's) tables for the record with a matching personal reference code. If no record is found, then processing module 236 notifies the company in Step 455 that the request for authentication could not be completed because the individual is not enrolled.

In Step 450, if processing module 236 identifies a record with a matching personal reference code, processing module 236 then compares the biometric template received with the authentication request against the biometric template stored in Database 100 (the enrolled/registered biometric template). If the two biometric templates match to within a predetermined margin of error, networking module 232 sends a response in Step 455 notifying the company that the identity submitted is valid, i.e. the identity's enrollment is authenticated. Such a response may include a “YES” or “Authentication Confirmed” signal and may be delivered to the requesting entity and/or any approved destination 240. If the two biometric templates fail to match to within the predetermined margin of error, networking module 232 sends a response in Step 455 notifying the company that the submitted identity is not valid. Such a response may include a “NO” or “Authentication Denied” signal and may be delivered to the requesting entity and any approved destination 240. If an anomaly occurs, which is defined as a matching function that results in a false match of codes or templates, or results in a match score that is lower than acceptable for affirmation of authentication, a signal is generated that indicates that results “require investigation” and that provides a form-of-problem definition for the requesting entity and approved destination 240 designated by the individual.

In Step 460, the company receives notification of the success or failure of the verification of the employee's identity in Database 100. If it is determined in Step 465 that the identity was verified, in Step 475 an indication of the authentication of the employee's identity is made. If it is determined in Step 465 that the identity was not verified, in Step 480 the company rejects the employee's request.

An exemplary embodiment using courier templates is now described. After the employee makes a request for authentication in Step 405, in step 412, an authorized representative or agent of the company presents his or her personal reference code and, in Step 428, presents his or her biometric for template evaluation, in addition to the employee's biometric and personal reference code provided in Steps 420 and 425, as previously described. In Step 430, this representative's or administrator's biometric is converted to a template and submitted with the employee's biometric template in Step 435. Because the client-representative's or administrator's template accompanies the employee's template in Step 435, it is referred to as a “courier template.”

In the check for authorization in Step 445, the identity of the courier template is verified using the processes described above for Step 450, i.e. in Step 445, processing module 236 determines whether the courier template is enrolled in Database 100. If processing module 236 determines that the courier template is enrolled, i.e., that the courier template matches a previously enrolled template for a representative or administrator of the company, the authentication request is considered an authorized request, and the employee's template is analyzed in Step 450 to determine whether it is enrolled. The process continues in Step 455 as previously described. It is appreciated that courier templates are not limited to representatives or administrators of companies, but may be for any individual authorized by the company, organization, group, etc. to submit verification requests.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for enrolling anonymous identity-related information in a biometric database comprising a plurality of biometric templates, the method comprising:
receiving a further biometric template in an enrollment request;
making a determination of whether the received further biometric template matches, to within a predetermined margin of error, at least one of the plurality of biometric templates stored in the database;
storing the received further biometric template in the database based on a result of the determination; and
supplying an indication of a result of the enrollment request.

2. The method of claim 1, further comprising:
receiving a personal reference code; and
storing the received personal reference code in the database based on the result of the determination.

3. The method of claim 2, wherein the storing of the received further biometric template and the received personal reference code further comprises storing the personal reference code and the received further biometric template in a record in the database.

4. The method of claim 1, wherein the database further comprises a plurality of personal reference codes, the method further comprising:
receiving a further personal reference code;
comparing the received further personal reference code against the plurality of personal reference codes; and
storing the received further personal reference code in the database based on the result of the determination and a result of the comparison,
wherein the storing of the received further biometric template is further based on the result of the comparison.

5. The method of claim 1, further comprising:
receiving a courier biometric template; and
making a determination of whether the courier biometric template corresponds to an entity authorized to request enrollments in the database,
wherein the storing is further based on a result of the determination of whether the courier template corresponds to an authorized entity.

6. The method of claim 5, wherein the storing is bypassed if the determination relating to the courier template indicates that the received courier template does not correspond to an entity authorized to request enrollments in the database.

7. The method of claim 1, wherein the database further comprises a set of cumulative enrollments comprising biometric templates of previous enrollments and the making of the determination further comprises comparing the received further biometric template against one or more of the biometric templates stored within the set of cumulative enrollments.

8. The method of claim 7, wherein the making of the determination further comprises:
determining a type of the received further biometric template; and
comparing the received further biometric template against those biometric templates in the set of cumulative enrollments having a type that matches the determined type.

9. The method of claim 7, further comprising receiving an indication of a type of the received further biometric template.

10. The method of claim 9, wherein the making of the determination further comprises comparing the received further biometric template against those biometric templates in the set of cumulative enrollments having a type that matches the received indication.

11. The method of claim 1, wherein the storing further comprises storing an indication of a type of the received further biometric template in the database.

12. The method of claim 11, wherein the storing further comprises storing the received further biometric template and the indication of the type of the received further biometric template in a record in the database.

13. The method of claim 1, wherein the receiving further comprises receiving the further biometric template from an entity and the storing further comprises storing the received further biometric template in a table in the database corresponding to the entity.

14. The method of claim 13, wherein when the determination indicates that the received further biometric template matches, to within the predetermined margin of error, at least one of the plurality of biometric templates stored in the database, the storing is allowed if entities corresponding to the at least one of the plurality of biometric templates permit such storing.

15. The method of claim 1, wherein the storing is bypassed if the determination indicates that the received further biometric template matches, to within the predetermined margin of error, at least one of the plurality of biometric templates stored in the database.

16. The method of claim 1, wherein the biometric template is created from a biometric of an animal other than a human being.

17. The method of claim 1, wherein the biometric template is created from a biometric of a human being.

18. The method of claim 1, wherein the received further biometric template is a universal biometric template, and the making of the determination further comprises comparing the received further biometric template against those biometric templates in the database that are universal biometric templates.

19. The method of claim 1, wherein the supplying of the indication further comprises reporting the result the enrollment request to an approved destination for resolution of any problems or issues associated with a failed enrollment.

20. A method of authenticating an identity of an individual within a database of anonymous records, each comprising at least one biometric template and a personal reference code, the method comprising:
receiving an authentication request from the individual, the authentication request comprising a personal reference code and a biometric template for a biometric feature of the individual;
making a determination of whether any record stored in the database exists comprising a stored personal reference code that matches the personal reference code of the authentication request;
comparing the biometric template of the authentication request with the biometric template of the record based on a result of the determination; and
providing an indication of a result of the comparison.

21. The method of claim 20, wherein the authentication request from the individual is submitted by an entity, the method further comprising determining whether the entity is authorized to submit the authentication request.

22. The method of claim 21, wherein:
the authentication request is submitted by a computer associated with the entity,
the receiving further comprises receiving an identification associated with the computer, and
the determining further comprises comparing the identification against a list of identifications associated with approved submitting computers.

23. The method of claim 21, further comprising receiving a courier biometric template,
wherein the determining further comprises identifying whether the received courier biometric template corresponds to an entity authorized to submit authentication requests, and
wherein the making of the determination is performed if the received courier biometric template corresponds to an authorized entity.

24. The method of claim 23, wherein the making of the determination is bypassed if the received courier biometric template does not correspond to an entity authorized to submit authentication requests.

25. The method of claim 20, wherein the individual is a human being.

26. The method of claim 20, wherein the individual is an animal other than a human being.

27. Computer executable software code stored on a computer-readable tangible medium, the code for:
receiving a biometric template in an enrollment request;
accessing a biometric database comprising a plurality of biometric templates;
making a determination of whether the received biometric template matches, to within a predetermined margin of error, at least one of the plurality of biometric templates stored in the database;
storing the received biometric template in the database based on a result of the determination; and
supplying an indication of a result of the enrollment request.

28. Computer executable software code stored on a computer-readable tangible medium, the code for:
receiving an authentication request from an individual, the authentication request comprising a personal reference code and a biometric template for a biometric feature of the individual;
accessing a database of anonymous records, each record comprising at least one biometric template and a personal reference code;
making a determination of whether any record stored in the database exists comprising a stored personal reference code that matches the personal reference code of the authentication request;
comparing the biometric template of the authentication request with the biometric template of the record based on a result of the determination; and
providing an indication of a result of the comparing.
